(19) United States
(12) Patent Application Publication
(10) Pub. No.: US 2010/0050465 A1
(43) Pub. Date: Mar. 4, 2010

(54) OPERATING METHOD FOR DRUM TYPE LAUNDRY MACHINE

(76) Inventors: Myong Hun Im, Seoul (KR); Soo Young Oh, Seoul (KR); Jae Won Chang, Seoul (KR); Kyung Chul Woo, Seoul (KR); Kyeong Hwan Kim, Seoul (KR)

Correspondence Address: MCKENNA LONG & ALDRIDGE LLP, 1900 K STREET, NW, WASHINGTON, DC, 20006, US

(21) Appl. No.: 12/450,606

(22) PCT Filed: Apr. 4, 2008
(86) PCT No.: PCT/KR2008/001903

§ 371 Date: Oct. 2, 2009

(30) Foreign Application Priority Data
Apr. 5, 2007 (KR) 10-2007-0033806

(51) Int. Cl. F26B 7/00; F26B 3/02

(52) U.S. Cl. 34/380; 34/499

(57) ABSTRACT

An operating method for a drum type laundry machine including a drum (300) for receiving laundry, an air supply unit (600) for supplying air into the drum (300), and a steam generation unit (400) supplying steam into the drum (300), the operating method comprising the steps of supplying cool air into the drum (300) to remove dust from the laundry; supplying steam into the drum (300) to remove wrinkles from the laundry; and resupplying cool air into the drum (300).

### TECHNICAL FIELD

The present invention relates to a laundry method, and more particularly, to a laundry method that is capable of removing dust and wrinkles from laundry.

### BACKGROUND ART

Generally, a washing machine is a machine that washes clothes and bedclothes (hereinafter, referred to as ‘laundry’) through a series of processes, such as washing, rinsing, and spin-drying, to remove contaminants from the laundry using the action of water and detergent. In the washing machine, when water and detergent are supplied into a tub, and laundry is put in a drum mounted in the tub, the drum is rotated by a motor to perform a washing operation, a rinsing operation, and a spin-drying operation of the laundry. In the washing operation, the laundry is washed by a cleaning force of the detergent supplied into the tub together with the water. In the rinsing operation, the laundry is rinsed by clean water supplied into the tub. In the spin-drying operation, the laundry is centrifugally spin-dried by a centrifugal force of the drum.

The spin-drying operation is carried cut, at the point of time when the washing operation and the rinsing operation have been completed, to centrifugally remove the wash water, absorbed in the laundry, from the laundry.

At the end of the washing operation and the rinsing operation, on the other hand, a drainage step for draining the wash water used to wash or rinse the laundry outside. The drainage step is continuously carried out to drain even the wash water centrifugally removed from the laundry until the spin-drying operation is completed.

Meanwhile, a washing-and-drying machine and a clothes drying machine, which have been widely used in recent years, are constructed in a structure in which high-temperature hot air is supplied into the drum to dry wet laundry.

In the conventional washing-and-drying machine and the conventional clothes drying machine, however, wrinkles as well as dust are left on the laundry dried by the washing-and-drying machine and the clothes drying machine, but such conventional laundry machines do not provide an additional operating method for solving such problems. As a result, a user cannot immediately use the laundry to which the washing and the drying have been completed, but must separately perform a step of removing or eliminating dust and wrinkles from the washed and dried laundry.

Meanwhile, when the laundry machine, such as the washing machine or the washing-and-drying machine, is used to remove dust from laundry, the dust may be removed from the laundry using wash water. In this case, however, time and energy are wasted, and the service life of the laundry is shortened due to unnecessary washing. For the drying machine, on the other hand, an operating method for the drying machine to remove dust or wrinkles from laundry has not yet been provided.

### DISCLOSURE OF INVENTION

### Technical Problem

Accordingly, the present invention is directed to an operating method for a drum type laundry machine that substantially obviates one or more problems due to limitations and disadvantages of the related art.

An object of the present invention is to provide an operating method for a drum type laundry machine that is capable of removing or eliminating dust and wrinkles from laundry without using wash water.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solution

To achieve these objects and other advantages and in accordance with the purpose of the invention, as embodied and broadly described herein, an operating method for a drum type laundry machine including a drum for receiving laundry, an air supply unit for supplying air into the drum, and a steam generation unit for supplying steam into the drum includes supplying cool air into the drum to remove dust from the laundry, supplying steam into the drum to remove wrinkles from the laundry, and resupplying cool air into the drum.

Preferably, the operating method further includes driving the drum to shake the laundry received in the drum, and the step of driving the drum is carried out simultaneously when at least one selected from a group consisting of the step of supplying cool air into the drum, the step of supplying steam into the drum, and the step of resupplying cool air into the drum is carried out. Preferably, the step of driving the drum includes a drum drive interval in which a motor is energized, and therefore, the drum is driven by the motor, and a drum pause interval in which the supply of power to the motor is interrupted, or the step of driving the drum only includes a drum drive interval.

Preferably, when the step of driving the drum includes the drum drive interval in which the motor is energized, and therefore, the drum is driven by the motor, and the drum pause interval in which the supply of power to the motor is interrupted, the rotation speed of the drum in the drum drive interval is 40 to 50 RPM, and the drum drive interval is continued for 6 seconds to 9 seconds.

Preferably, the step of supplying cool air into the drum is carried out for a longer period of time than the step of supplying steam into the drum.

It is to be understood that both the foregoing general description and the following detailed description of the present invention are exemplary and explanatory and are intended to provide further explanation of the invention as claimed.

### ADVANTAGEOUS EFFECTS

As apparent from the above description, the operating method for the drum type laundry machine according to the present invention has the effect of removing or eliminating dust and wrinkles from laundry without using wash water.

Since the wash water is not used, it is possible to prevent the damage to the laundry doe to an excessive laundry process. Also, it is possible to removed moisture from the laundry and vivify the textures or strands of the laundry through the supply of steam and cool air, thereby maintaining the laundry in a pleasant state.

Furthermore, the operating method for the drum type laundry machine according to the present invention has the effect of allowing the user to select a dust and wrinkles removing course according to the present invention, thereby simultaneously achieving the removal of dust and the removal of wrinkles.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a side sectional view illustrating the interior structure of a laundry machine according to the present invention;

FIG. 2 is a plan view illustrating the interior structure of the laundry machine according to the present invention;

FIG. 3 is a flow chart illustrating an operating method for a drum type laundry machine according to the present invention;

FIG. 4 is a graph illustrating a correlation between rotation speeds (RPM) of a drum based on time when the drum is rotated in a tumble mode, which is one of drum driving modes;

FIG. 5 is a view illustrating laundry used in experiments according to the present invention and reflexibility measurement positions on the laundry;

FIG. 6 is a graph illustrating a correlation between the continuance time of a drum drive interval, the rotation speed (RPM) of the drum, and the deviation of optical reflexibility in the operating method for the drum type laundry machine according to the present invention; and

FIG. 7 is a graph illustrating a correlation between the continuance time of a drum pause interval and the deviation of reflexibility when the drum of the laundry machine is driven in the tumble mode.

### MODE FOR THE INVENTION

Reference will now be made in detail to the preferred embodiments of the present invention, examples of which are illustrated in the accompanying drawings. Wherever possible, the same reference numbers will be used throughout the drawings to refer to the same or like parts.

The preferred embodiments of the present invention will be described hereinafter on the assumption that a laundry machine used in the present invention is a washing-and-drying machine. Of course, the laundry machine may be a clothes drying machine.

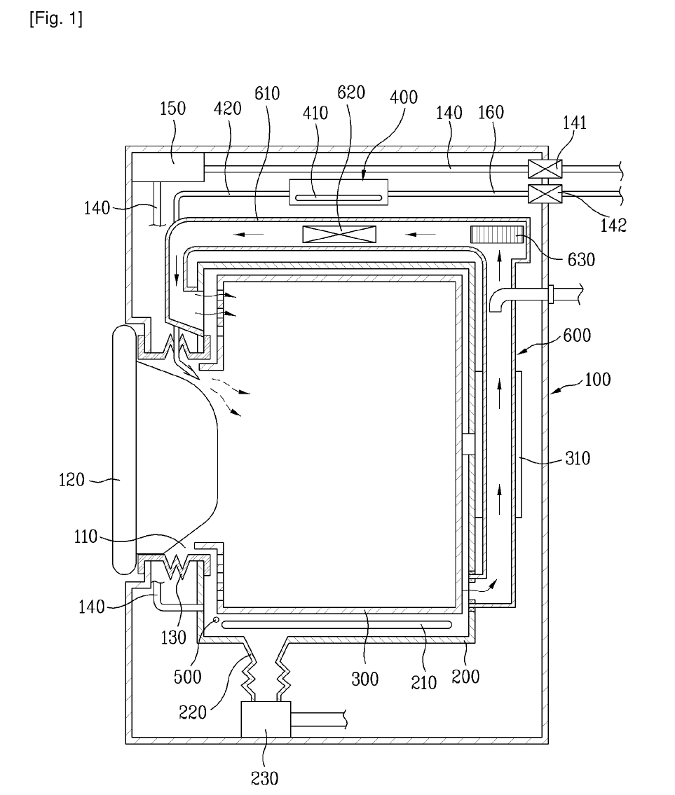

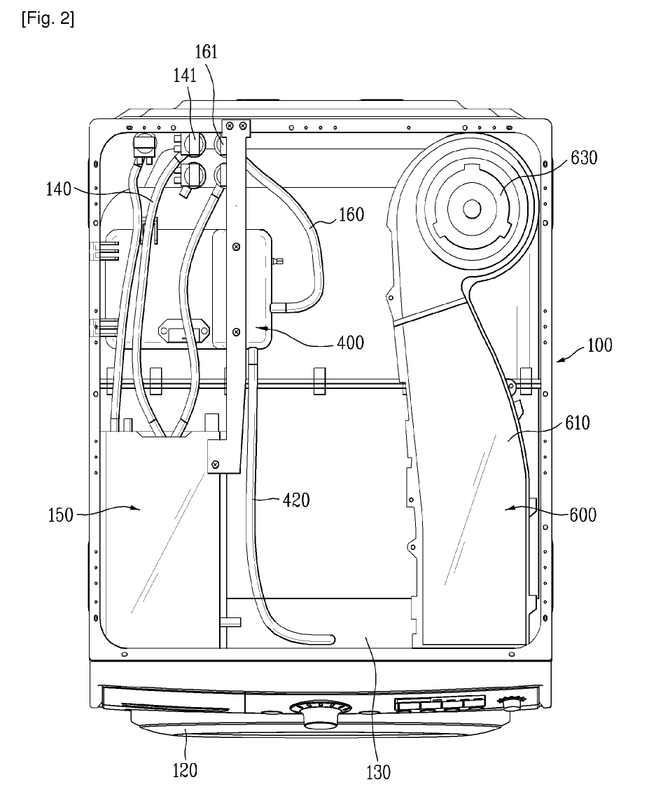

First, as shown in FIGS. 1 and 2, the laundry machine according to a preferred embodiment of the present invention includes a machine body 100, a tub 200, a drum 300, a steam generation unit 400, a temperature sensor 500, and an air supply unit 600.

The machine body 100 forms the external appearance of the laundry machine. The machine body 100 has an inlet port 110 formed at the front thereof.

At the machine body 100 where the inlet port 110 is formed is mounted a door 120 for opening and closing the inlet port 110. At the inner circumference of the inlet port 110 is mounted a gasket 130 for securing the seal between the door 120 and the inlet port 110.

In the machine body 100 is mounted a wash water supply pipe 140 for supplying wash water into the tub 200.

In the machine body 100 is also mounted a detergent box 150. The wash water supply pipe 140 is connected to the tub 200 via the detergent box 150 such that the wash water supply pipe 140 communicates with the interior of the tub 200.

The tub 200 is mounted in the machine body in a supported fashion.

At the lower part of the tub 200 is mounted a wash water heater 210 for heating wash water supplied into the tub 200.

A drainage channel 220 for draining wash water is connected to the bottom of the tub 200.

On the drainage channel 220 is mounted a drainage pump 230 that can be driven to forcibly drain wash water.

The drum 300 is rotatably mounted in the tub 200. The drum 300 is located in the tub 200 such that the open side of the drum 300 is directed toward the inlet port 110 of the machine body 100.

To the rear of the drum 300 is coupled a drive unit 310 for rotating the drum 300.

The steam generation unit 400 is constructed to supply a predetermined amount of steam into the drum 300 (or tub). At least one stem generation unit 400 is provided. FIG. 2 is a plan view illustrating an installation example of the steam generation unit 400.

The steam generation unit 400 includes a heat generator 410 for heating water stored therein to generate steam and a steam supply pipe 420 for guiding the flow of the generated steam.

The steam supply pipe 420 preferably extends through the gasket 130 such that the steam discharge side of the steam supply pipe 420 is directed toward the interior of the drum 300.

The temperature sensor 500 serves to sense the interior temperature of the tub 200. The temperature sensor 500 is preferably mounted in the tub 200.

The interior temperature of the tub 200, sensed by the temperature sensor 500, may be used to control the operation of the steam generation unit 400 or the operation of the air supply unit 600.

The air supply unit 600 is used to dry laundry. The air supply unit 600 is constructed to supply high-temperature hot air or cool air into the drum 300.

The air supply unit 600 includes an air duct 610, a drying heater 620, a blowing fan 630, and a fan motor (not shown).

The air duct 610 is mounted such that opposite ends of the air duct 610 communicate with the interior of the tub 200. Preferably, one end of the air duct 610 is connected to the rear side of the tub 200, and the other end of the air duct 610 is connected to the front side of the tub 200. Of course, the air duct 610 may be mounted such that one end of the air duct 610 communicates with the interior of the tub 200, and the other end of the air duct 610 communicates with the outside of the machine body 100.

The drying heater is mounted in the air duct 610 for heating air flowing in the air duct 610 to generate hot air.

The blowing fan 630 and the fan motor are mounted in the air duct 610 for blowing air from the air duct 610 into the drum 300 through the drying heater 620.

Meanwhile, unexplained reference numeral 160 indicates a steam water supply pipe for supplying water to the steam generation unit 400. In the laundry machine according to the present invention, therefore, water to be supplied into the steam generation unit is distinguished from wash water. Consequently, wash water containing detergent is not supplied to the steam generation unit 400. The steam generation unit 400 is mounted while the steam generation unit 400 is separated from the tub 200.

Also, unexplained reference numerals 141 and 161 indicate opening and closing valves for opening and closing the wash water supply pipe 140 and the steam water supply pipe 160, respectively.

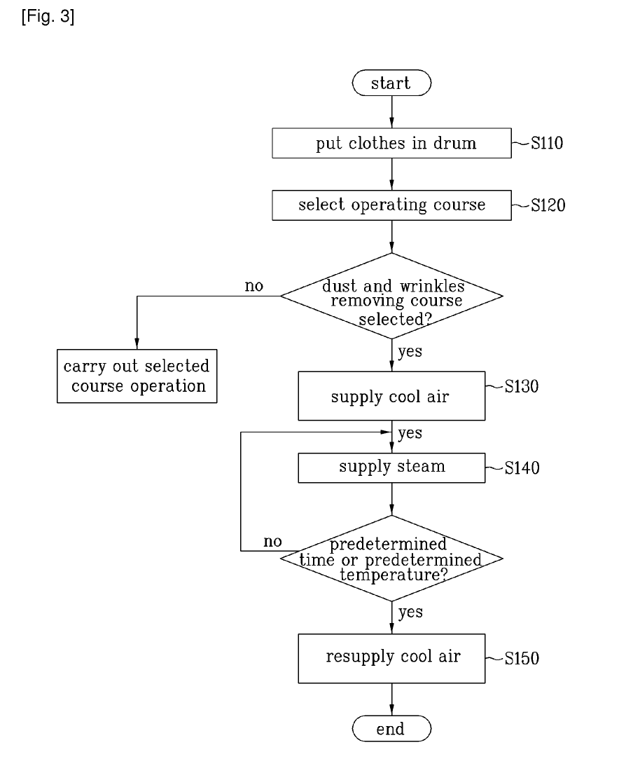

Hereinafter, an operating method for a drum type laundry machine according to a preferred embodiment of the present invention will be described with reference to a flow chart illustrated in FIG. 3.

FIG. 3 is a flow chart illustrating an operating method for a drum type laundry machine according to the present invention.

First, a user puts laundry from which dust and wrinkles are to be removed in the drum (S110). Then, the user selects an operating course for removing dust or wrinkles (hereinafter, referred to as a ‘dust and wrinkles removing course’), among a plurality of operating courses (S120). Consequently, when the user selects the dust and wrinkles removing course, the laundry machine is operated according to an operating method corresponding to the dust and wrinkles removing course. On the other hand, when the user selects another operating course, the laundry machine is operated according to an operating method corresponding to the selected operating course.

Here, the laundry may be one either before washing or after washing. Of course, when the laundry is one after washing, the laundry has already been spin-dried, and therefore, the laundry may contain a small amount of water therein. The dust and wrinkles removing course, as the operating method for the drum type laundry machine according to the present invention, may be carried cut independently from the washing of the laundry.

Subsequently, a controller (not shown) controls the operation of the air supply unit to supply cool air to the laundry in the drum. This step is a cool air supplying step (S130).

The cool air does not mean a low-temperature air which is cooled but a room-temperature air which is not heated. The cool air is supplied into the drum by the air supply unit 600, which includes the air duct 610, the drying duct 620, the blowing fan 630 and the fan motor (not shown), as shown in FIG. 1. The air to be supplied into the drum is cool air, and therefore, the drying heater 620 is not operated.

The supply of cool air is continued for a predetermined period of time such that the cool air can be continuously supplied into the drum. Here, the drum is preferably is driven simultaneously with the supply of the cool air such that the cool air can be uniformly supplied to the laundry. That is, the cool air is uniformly supplied to the laundry by the repetitive lifting and dropping of the laundry.

Of course, during the operation of the drum, the supply of cool air may be repeatedly carried out. At the cool air supplying step (S130), the drum is driven such that the laundry is repeatedly lifted and dropped, and, at this time, the cool air is supplied to the laundry. Consequently, particles, such as dust, contained in the laundry is separated and removed from the laundry.

Particle-shaped substance floating in the air is generally called dust. In particular, dust means solid particles having a diameter of 0.1 μm to several tens of gum, generated when solids, such as soil, sand, rocks, metal, and plants, are crushed. In a broad sense, dust means all kinds of fine-grained substance floating in the air. Also, dust includes fine grain level substance separated from fibers of laundry itself. Clothes are generally configured in the form of a woven fabric having raised hair. For this reason, dust is easily adhered to the clothes. Dust may be removed from the clothes by using a method of physically shaking the dust from the clothes or a method of washing the clothes with wash water to remove dust located between fibers.

In the operating method for the drum type laundry machine according to the present invention, dust is removed from laundry by using a method similar to the former method which does not use wash water. Specifically, laundry in the drum, into which cool air is supplied, is repeatedly lifted and dropped such that dust can be separated from the laundry by an air current. By using this method, it is possible to remove dust containing various kinds of bacteria and giving rise to aesthetic unpleasantness. In this case, it is preferred for the drum to be rotated in alternating directions such that the laundry is not merely rotated in the drum but the laundry is lifted and dropped. When the laundry is exposed to cool air while the laundry is dropped in the drum, dust is separated from the laundry and is then discharged through an exhaust port.

The decision of the details of the operating method for the drum type laundry machine according to the present invention is based on the decision of the driving mode and rotation speed of the drum and the continuance time of a drum drive interval. Consequently, the driving mode and rotation speed of the drum and the continuance time of the drum drive interval, optimized for the drum type laundry machine, will be studied. As experiments for such study, the following experiments have been carried cut to determine the dust removing efficiency of the operating method for the drum type laundry machine according to the present invention.

In the experiments, laundry to experiment on was uniformly contaminated with substance serving as dust, the laundry operation was carried cut by using the operating method for the drum type laundry machine according to the present invention, and the removal percentage of the substance was measured.

The principle of the experiments is to measure and compare the optical reflexibilities of the laundry contaminated by the dust. When light is irradiated to the surface of laundry made of fibers, a specific amount of the light is reflected from the laundry. The scattered percentage of the light is fixed with respect to the same fiber texture.

When light is irradiated to a fiber texture contaminated by dust, a smaller reflexibility is measured than when light is irradiated to the same fiber texture not contaminate by the dust. This is because dust particles scatter the light, and therefore, the amount of the light reflected is reduced.

The substance, serving as dust, used in the experiments for testing the efficiency of the operating method for the drum type laundry machine according to the present invention is pine pollen. The reason to use the pine pollen is that the particle size of the pine pollen is similar to that of dust, and the pine pollen is substance that can be physically separated from laundry.

It is required for the experiments to be carried cut with respect to various operating methods in order to compare dust removal efficiencies achieved by the operating method for the drum type laundry machine according to the present invention. Consequently, predetermined regions at the same positions of same kind of several laundry articles to experiment on are contaminated by the above substance. Specifically, a predetermined concentration of pine pollen is applied to the surfaces of same kind of several laundry articles to experiment on, and the amounts of the respective laundry articles contaminated by the pine pollen are adjusted until the reflexibility before the experiments is measured equally by an optical reflexibility measuring apparatus (a color measuring apparatus using the reflected light component of light). The same fibers exhibit the same reflexibility when the fibers are not contaminated. Consequently, when the amount of pine pollen is adjusted such that the same reflexibility is measured, it is considered that the same fiber textures are contaminated to the same extent.

When the reflexibilities at the corresponding regions of the laundry articles processed by the operating method for the drum type laundry machine according to the present invention are measured and the difference between the measured reflexibilities are compared, the optical reflexibilities will increase in proportion to the amount of the dust removed after the experiments. The increase of the difference between the measured reflexibilities means high dust removal efficiency.

At the step of measuring the optical reflexibilities, at least two regions of the same laundry article are selected, and the mean value of the measured reflexibilities are calculated.

FIG. 5 is a view illustrating a laundry article used in the experiments according to the present invention and reflexibility measurement positions on the laundry article. As shown, the reflexibilities at four positions within an experiment region of the laundry article were measured, and the average reflexibility was calculated from the measured reflexibilities, in the experiments according to the present invention.

TABLE 1

| | | Average re- | Average re- | |
|---|---|---|---|---|
| | | flexibility | flexibility | |
| | | before | after | |
| Mode | Variable | experiments | experiments | Difference |
| Spin mode | 100 | 66.63 | 69.68 | 3.05 |
| | 200 | 66.67 | 70.50 | 3.83 |
| | 300 | 66.15 | 69.57 | 3.42 |
| Tumble mode | 45/7/1 | 65.82 | 77.44 | 11.62 |
| Swing mode | 45/1/0 | 65.91 | 77.09 | 11.18 |

Table 1 above is a comparison table of the optical reflexibilities of the laundry article processed by various operating methods for the laundry machine.

The operating methods for the drum type laundry machine used in the present experiments are classified into a spin mode in which the drum of the laundry machine is continuously rotated at high speed in one direction, a tumble mode in which the drum of the laundry machine is rotated in alternating directions with predetermined pause periods, and a swing mode in which the rotation direction of the drum of the laundry machine is changed for predetermined time intervals, which are classified based on the driving mode of the drum of the laundry machine.

As can be seen from Table 1 above, the average reflexibilities at the experiment region before the experiments were 66.63, 66.67, 66.15, 65.82, and 65.91, which were similar to one another. This results were obtained by adjusting the contamination degree of the same kind of laundry articles such that the reflexibilities of the laundry articles were approximate to the same value. This means that pine pollen was applied to the experiment regions of the same kind of five laundry articles such that the mean values of the reflexibilities of the laundry articles are almost the same. The data of the reflexibilities after the experiments are also indicated in Table 1 above.

In the experiments of the present invention, the drum was driven in three spin modes, in one tumble mode, and in one swing mode. As indicated in Table 1 above, the experiments in the spin modes revealed that that the differences between the reflexibilities before the experiments and the reflexibilities after the experiments were not great. In the experiments in swing mode and in the tumble mode, however, it can be seen that the reflexibilities after the experiments were greater than the reflexibilities before the experiments.

The reason why the reflexibilities were changed as indicated in Table 1 above will be described in the following. The swing mode is a mode in which the drum is rotated without a stop while the rotation direction of the drum is changed at predetermined time intervals. Specifically, the experiments were carried out while the drum was rotated in alternating directions at one-second intervals. At this time, the rotation speed of the drum was set to be 45 RPM, which was the same rotation speed as that of the drum in the tumble mode. ‘45/1/0’ indicated in Table 1 above means that the drum was rotated at 45 RPM in alternating directions at one-second intervals.

In the tumble mode of the operating method for the drum type laundry machine, the continuance time of the drum drive interval was set to be 7 seconds, and the continuance time of the drum pause interval was set to be 1 second. At this time, the rotation speed of the drum was set to be 45 RPM, which is revolutions per minute. This drum driving condition is indicated in the form of ‘45/7/1’ in Table 1 above.

In the spin mode, the drum is rotated in high rotation speed, and therefore, laundry is rotated while the laundry clings to the inner circumference of the drum, with the result that the amount of dust removed from the laundry by cool air supplied into the drum is not large. In the spin mode, the rotation speeds of the drum were 100, 200, and 300 RPM, which means that the rotation speeds of the drum in the spin mode is higher than that of the drum in the swing mode or in the tumble mode, but the increase of the reflexibilities is relatively small. Consequently, the spin mode is not suitable when the laundry machine is used to remove dust from laundry.

Even when the rotation speeds of the drum are the same, it is confirmed that the increase of the reflexibilities in the tumble mode are very similar to the increase of the reflexibilities in the swing mode according to the results of the experiments indicated in Table 1 above. Consequently, it can be seen that it is preferred to rotate the drum in the tumble mode or in the swing mode when dust is to be removed from laundry according to the operating method for the drum type laundry machine. When the drum is driven in the tumble mode, the drum driving step includes drum drive intervals in which the motor is energized, and therefore, the drum is driven by the motor, and drim pause intervals in which the supply of power to the motor is interrupted. On the other hand, when the drum is driven in the swing mode, the drum driving step includes only the drum drive interval.

Hereinafter, optimum driving conditions when the drum of the laundry machine is driven in the tumble mode in the operating method for the drum type laundry machine according to the present invention will be described in detail.

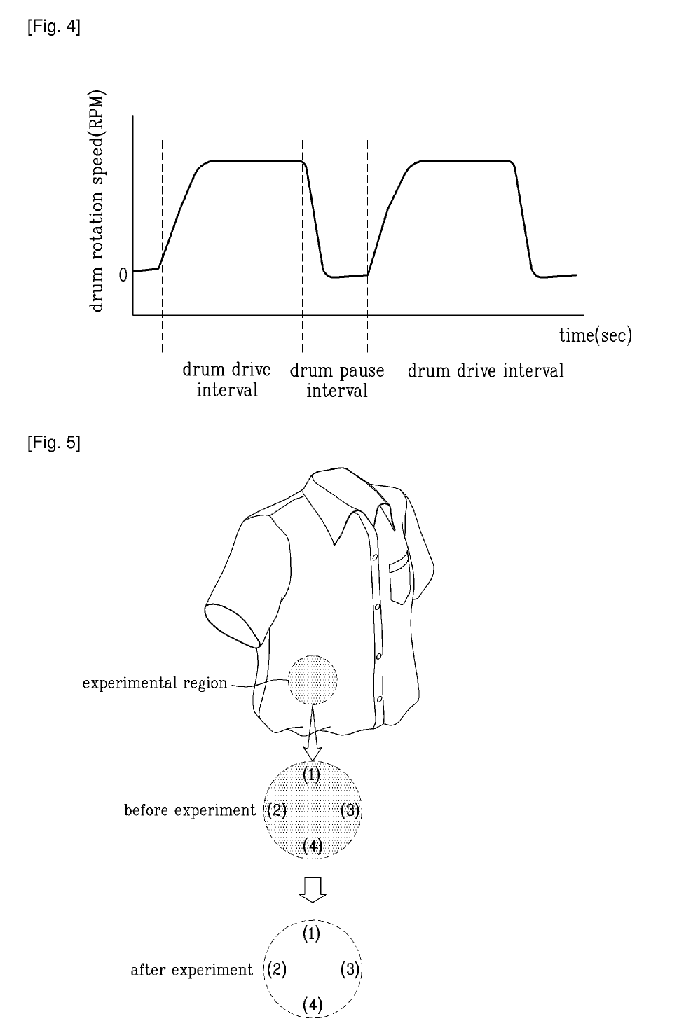

FIG. 4 is a graph illustrating a correlation between rotation speeds (RPM) of the drum based on time when the drum is rotated in the tumble mode, which is one of the drum driving modes. The drum driving step, at which the drum is driven, includes drum drive intervals in which the motor is energized, and therefore, the drum is driven by the motor, and drum pause intervals in which the supply of power to the motor is interrupted. As shown in FIG. 4, the rotation speed of the drum is sharply increased in the respective drum drive intervals, and the drum is not rotated but stopped in the respective drum pause intervals. That is, the drum is driven according to a pattern in which the drum is rotated in the forward direction for a predetermined period of time, the drum is stopped for a predetermined period of time, and the drum is rotated in the reverse direction for a predetermined period of time.

In the tumble mode, the drum is rotated in alternating directions, and therefore, laundry in the drum is repeatedly lifted and dropped. While the process is continued, cool air is supplied into the drum, and therefore, dust is separated from the laundry by the cool air. For this reason, the dust removal efficiency is higher when the drum is driven in the tumble mode than when the drum is driven in the spin mode.

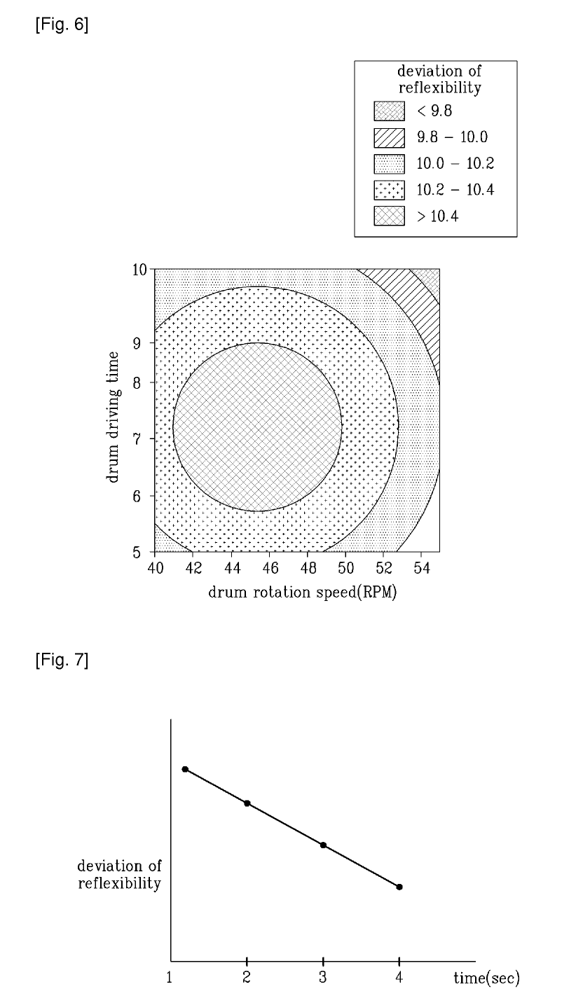

FIG. 6 is a graph illustrating a correlation between the continuance time of the drum drive interval, the rotation speed (RPM) of the drum, and the deviation of optical reflexibility, when the drum is driven in the tumble mode in the operating method for the drum type laundry machine according to the present invention. Partitioned regions on concentric circles of the graph illustrating the results of the experiments each have the deviation of reflexibility of the same range. The graph of FIG. 6 also illustrates that the region in the innermost circle has the greatest deviation of the reflexibility. As shown in FIG. 6, it can be seen that the deviation of reflexibility is great when the rotation speed of the drum is between 40 and 50 RPM. At this time, the continuance time of the drum drive interval is 6 seconds to 9 seconds.

Consequently, when the drum of the drum type laundry machine is driven in the tumble mode in the operating method for the drum type laundry machine according to the present invention, the rotation speed of the drum is preferably between 40 and 50 RPM, and the continuance time of the drum drive interval is preferably 6 seconds to 9 seconds. If the rotation speed of the drum is too high, the laundry clings to the inner circumference of the drum by a centrifugal force, with the result that the laundry is rotated along with the drum. Consequently, it is necessary to control the rotation speed of the drum.

FIG. 7 is a graph illustrating a correlation between the continuance time of the drum pause interval and the deviation of reflexibility when the drum of the laundry machine is driven in the tumble mode. The deviation of reflexibility was measured while the drum drive interval was set to be 7 seconds, the rotation speed of the drum was set to be 45 RPM, and the continuance time of the drum pause interval was changed. Specifically, the deviation of the reflexibility was measured when the continuance time of the drum pause interval was 1 second, 2 seconds, 3 seconds, and 4 seconds. The deviation of the reflexibility was the greatest when the continuance time of the drum pause interval was 1 second. This is because, when the ratio of the drum pause interval to the total operation time of the laundry machine increases while the drum is driven for the same operation time, time to remove dust from the laundry by the supplied cool air decreases during the repetitive lifting and dropping of the laundry, with the result that the deviation of the reflexibility is reduced.

Also, when the drum pause interval is long, the total operation time of the drum type laundry machine must be increased in order to obtain the same deviation of the reflexibility.

Also, when the drum of the laundry machine is driven in the tumble mode in the embodiment of the present invention, the ratio of the continuance time of the drum drive interval to the continuance time of the drum pause interval is defined as a net action ratio. The net action ratio is calculated from the ratio of the continuance time of the drum drive interval to the continuance time of the drum pause interval.

When the net action ratio increases, it is experimentally confirmed that the tangle and wrinkles of laundry decrease. In the embodiment of the present invention, the continuance time of the drum drive interval is preferably between 6 seconds and 9 seconds. The increase of the tangle of the laundry which has been passed through the dust and wrinkles removing course causes user's inconvenience. Consequently, it is preferred to control the driving of the drum, such that the net action ratio is great, in the operating method for the drum type laundry machine according to the present invention. Also, it is possible to equalize the net action ratio even when the continuance time of the drum drive interval to the continuance time of the drum pause interval are changed.

However, the increase of the continuance time of the drum pause interval causes the increase of time necessary to carry out the dust and wrinkles removing course. On the other hand, the decrease of the continuance time of the drum pause interval causes overload to the drum, which rotates the laundry in alternating directions. Consequently, it is preferred to appropriately choose the continuance time of the drum pause interval.

It can be seen from the graph illustrated in FIG. 6 that the dust removal efficiency is the greatest in the innermost circle among the concentric circles. Consequently, the continuance time of the drum drive interval is 7 seconds, and, at this time, the rotation speed of the drum is 45 RPM in the center of the innermost circle among the concentric circles of the graph illustrated in FIG. 6. Also, as previously described, it is preferred to set the continuance time of the drum pause interval to be 1 second such that the net action ratio is increased but overload is not applied to the drum.

Referring back to FIG. 3, the operating method for the drum type laundry machine according to the present invention will be further described.

After the completion of the cool air supplying step (S130), a steam supplying step of supplying steam into the drum (S140) is carried out. The steam is generated by the steam generation unit 400 of the drum type laundry machine shown in FIG. 1, which includes the heat generator 410 for heating water stored therein to generate steam and the steam supply pipe 420 for guiding the flow of the generated steam. The generated steam is supplied to the laundry in the drum through the steam supply pipe 420.

Of course, the drum is preferably driven at this step. The driving mode of the drum at this step is the same as at the previously described cool air supplying step (S130), and therefore, a detailed description thereof will not be given.

At the steam supplying step (S140), it is possible to remove wrinkles from the laundry. That is, it is possible to eliminate wrinkles left on the laundry or remove the wrinkles from the laundry by supplying the steam into the drum while the laundry in the drum is lifted and dropped. The steam penetrates between the finely-entangled wrinkle nets, and therefore, the wrinkles are eliminated or removed from the laundry. Specifically, an attractive force is applied between fiber molecules in the laundry of which the fibers are wrinkled. Consequently, when heat and water penetrates between the fiber molecules between which the attractive force is applied, the respective fibers swells and the fiber molecules are rearranged. After the removal of moisture, the wrinkles of the laundry are eliminated.

However, the steam supplying step (S140) for the removal of wrinkles is preferably carried cut for a shorter period time than the cool air supplying step (S130). This is because the supply of the steam requires a larger amount of energy than the supply of the cool air, and, when an excessive amount of steam is supplied to the laundry, the laundry may become wet, with the result that an additional drying process is required. In the embodiment of the present invention, the cool air supplying step (S130) is carried cut for 15 minutes, and the steam supplying step (S140) is carried cut for 4 minutes. It was experimentally confirmed that, even when the cool air supplying step (S130) was carried out for more than 15 minutes, little difference was made in the dust removal efficiency.

A method for controlling the amount of steam supplied is to check the increase of the interior temperature of the drum or the tub due to high-temperature steam. The excessive increase of the temperature means that there is a supply of an excessive amount of steam. Consequently, it is possible to control the amount of steam supplied by checking the increase of the temperature. Of course, it is possible to control the amount of steam supplied by checking steam spray time for which steam is successively sprayed. Consequently, whether to complete the steam supplying step (S140) may be decided according to the temperature condition or the time passage condition.

After the completion of the steam supplying step (S140), cool air is preferably resupplied into the drum. In other words, a cool air resupplying step of resupplying cool air (S150) is carried out.

At the cool air resupplying step (S150), the drum is also preferably driven such that the cool air can be uniformly supplied to the laundry. At the cool air resupplying step (S150), it is necessary to prevent the laundry from wrinkling due to its own weight, since the wrinkles have already been removed from the laundry. Consequently, cool air is preferably supplied, and, at the same time, the drum is driven, even at the cool air resupplying step (S150). As previously described, the drum is preferably driven in the tumble mode in which the drum is rotated in alternating directions.

Meanwhile, the wrinkles, eliminated by the supply of the steam, are reliably and completely removed from the laundry by resupplying cool air for the purpose of removing the wrinkles. Of course, the cool air resupplying step (S150) may be controlled to be carried out for a predetermined period of time. In the operating method for the drum type laundry machine according to the present invention, the cool air resupplying step (S150) is carried out for 3 minutes.

Meanwhile, the laundry is completely dried and the textures or strands of the laundry are vivified through the supply of the cool air, whereby the laundry is maintained in a pleasant state.

The cool air supplying step may also be controlled to be carried out for a predetermined period of time. As previously described, when this step is completed, the supply of the cool air is interrupted, but the drum is preferably controlled to be continuously driven to prevent the generation of wrinkles on the laundry until the user opens the door or until a predetermined period of time elapses after the cool air is interrupted.

Also, as previously described, the operating method for the drum type laundry machine according to the present invention is preferably controlled such that all the steps are carried out automatically when the user selects any one operation course.

Also, in the operating method for the drum type laundry machine according to the present invention, the laundry in the drum is repeatedly lifted and dropped, and the cool air and the steam are repeatedly supplied into the drum, whereby it is possible to incidentally remove smells from the laundry.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As apparent from the above description, the operating method for the drum type laundry machine according to the present invention has the effect of removing or eliminating dust and wrinkles from laundry without using wash water.

Since the wash water is not used, it is possible to prevent the damage to the laundry doe to an excessive laundry process. Also, it is possible to removed moisture from the laundry and vivify the textures or strands of the laundry through the supply of steam and cool air, thereby maintaining the laundry in a pleasant state.

Furthermore, the operating method for the drum type laundry machine according to the present invention has the effect of allowing the user to select a dust and wrinkles removing course according to the present invention, thereby simultaneously achieving the removal of dust and the removal of wrinkles.

1. An operating method for a drum type laundry machine including a drum for receiving laundry, an air supply unit for supplying air into the drum, and a steam generation unit for supplying steam into the drum, the operating method comprising:
supplying cool air into the drum to remove dust from the laundry;
supplying steam into the drum to remove wrinkles from the laundry; and
resupplying cool air into the drum.

2. The operating method according to claim 1, further comprising:
driving the drum to shake the laundry received in the drum, the step of driving the drum being carried cut simultaneously when at least one selected from a group consisting of the step of supplying cool air into the drum, the step of supplying steam into the drum, and the step of resupplying cool air into the drum is carried cut.

3. The operating method according to claim 2, wherein the step of driving the drum includes a drum drive interval in which a motor is energized, and therefore, the drum is driven by the motor, and a drum pause interval in which the supply of power to the motor is interrupted, or the step of driving the drum only includes a drum drive interval.

4. The operating method according to claim 2, wherein, at the step of driving the drum, the drum is rotated in alternating directions.

5. The operating method according to claim 2, wherein the drum is driven for a predetermined period of time after the step of supplying cool air into the drum, the step of supplying steam into the drum, and the step of resupplying cool air into the drum are completed.

6. The operating method according to claim 3, wherein
when the step of driving the drum includes the drum drive interval in which the motor is energized, and therefore, the drum is driven by the motor, and the drum pause interval in which the supply of power to the motor is interrupted,
the rotation speed of the drum in the drum drive interval is 40 to 50 RPM, and
the drum drive interval is continued for 6 seconds to 9 seconds.

7. The operating method according to claim 6, wherein the drum drive interval is 6 times to 9 times as long as the drum pause interval.

8. The operating method according to any one of claims 1 to 7, wherein the step of supplying cool air into the drum is carried out for a longer period of time than the step of supplying steam into the drum.
